(19) United States
(12) Patent Application Publication
(10) Pub. No.: US 2004/0262567 A1
(43) Pub. Date: Dec. 30, 2004

(54) Stable compositions of liquefied refrigerant and UV dye

(75) Inventor: Monte Bruce Wilson, New South Wales (AU)

Correspondence Address: SUGHRUE MION, PLLC, 2100 PENNSYLVANIA AVENUE, N.W., SUITE 800, WASHINGTON, DC, 20037, US

(73) Assignee: PROEM PTY LTD.

(21) Appl. No.: 10/898,253

(22) Filed: Jul. 26, 2004

Related U.S. Application Data
(63) Continuation of application No. 09/830,187, filed on Jun. 25, 2001, now abandoned.

(30) Foreign Application Priority Data
Oct. 23, 1998 (AU) PP6711

(51) Int. Cl. G01M 3/04; C09K 5/00

(52) U.S. Cl. 252/68; 252/71

(57) ABSTRACT

A composition for the detection of leaks from a hermetic refrigerant system, such as refrigeration, heating, ventilation and air-conditioning systems, wherein a fluorescent dye or other visible indicator compound is combined with a suitable solvent, refrigeration system lubricant and a material suitable to function as a heat transfer agent or refrigerant in a hermetic system, as a permanent working composition. A method of detecting leaks in the hermetic system, based on the use of the composition, is also disclosed.

### TECHNICAL FIELD

The present invention relates to the detection of leaks in refrigeration systems, and to an improved leak detection composition and to a refrigerant composition incorporating same. The invention also relates to a method of formulating such compositions.

The invention is generally applicable to the detection of leaks from a hermetic refrigerant system, such as refrigeration, heating, ventilation and air-conditioning systems, wherein a fluorescent dye or other visible indicator composition is combined with a suitable refrigerant system lubricant and a material suitable to function as a heat transfer agent or refrigerant in a hermetic system.

The invention is especially directed towards locating refrigerant leaks from refrigerant systems using refrigerant substances other than chlorofluorocarbons (CFC) that have been banned under the Montreal Protocol.

### BACKGROUND ART

Refrigerants that are devoid of the chlorine atom and therefore considered environmentally friendly to the earth's ozone layer have been developed and continue to be developed to replace CFC and HCFC materials that are the circulating heat transfer media in many hermetic systems. Many chemical companies have developed products that alone or in combination are suitable to function as heat transfer agents or refrigerants in a hermetic system such as, but not limited to, hydro-chloro-fluorocarbons (HCFC), hydrofluorocarbons (HFC) and hydrogen, halogenated or ether derivatives of methane; hydrogen, halogenated, ether or cyclic derivatives of any of ethane, propane, butane, pentane; mixtures of HCFC, HFC, hydrocarbons, carbon dioxide and ammonia. These foregoing HCFC, HFC and hydrocarbon refrigerants are considered less damaging to the environment and have ozone depletion potentials which range from zero to a fraction of one, while the ozone depletion potential of a CFC refrigerant, such as CFC-12, is one.

The use of these new alternative refrigerants has required the use of new kinds of refrigeration system lubricants such as synthetic polyalkylene glycols (PAG) and polyolesters (POE) and has rendered prior leak detection chemicals employing materials such as those described in U.S. Pat. Nos. 4,758,366 and 5,149,453, issued on Jul. 19, 1988 and Sep. 26, 1992, respectively, as largely ineffective. These patents teach the use of perylene yellow fluorescent dyes formulated with mineral oils. Mineral oil is a hydrocarbon. Hydrocarbons such as synthetic hydrocarbons (SHC), alkylbenzene (AB), and polyalphaolefins (PAO) may only be partially soluble in polyalkiene glycol and in polyolester lubricants such as those used in the new HFC refrigerant-containing systems.

Leaks in refrigeration systems have up until the present invention been located by various methods, including the injection of a suitable dye material into the system and the detection of the residues of dye left on the surface of the system. For example, vehicle air-conditioning systems are prone to developing minor refrigerant leaks from small fatigue cracks and loose pipe connections brought about by the vibration that the systems are subjected to in use. The detection and location of the leaks is rendered difficult because the refrigerants in question are normally odourless and colourless.

Thus, it has become commonplace for diagnostic compositions containing dyes which fluoresce under the influence of ultra-violet radiation to be used to make the leaks obvious. Hitherto, it has been usual when servicing a leaky system to charge the system with a small quantity of the dye-containing composition, then if no gas was left in the system to add gas as well. Then, run the system to cause leakage of the composition with the gas and then detect the leak by detecting the residues of dye left on the surface of the system components at the site of the leak. See U.S. Pat. No. 5,421,192 re-issued under Re. 35,370 on 5 Nov. 1996.

This type of procedure is a laborious, lengthy procedure requiring the use of special injection equipment. It has also been disadvantageous for the service provider in that there is always the possibility of either under-dosing or over-dosing the system, or the accidental spillage of the diagnostic composition causing discoloration of the customer's vehicle and service equipment requiring elaborate clean up procedures. This can contribute significantly to servicing costs.

Attempts have been made to incorporate the dye material into the refrigerant in its pressurised storage cylinder as a permanent means of visual identification of refrigerant leakage from the gassed or regassed refrigeration system but previous attempts have been unsuccessful due primarily to chemical instability or insolubility.

Some new HFC systems reach higher operating temperatures and pressures than the old CFC systems because of different thermodynamic properties. Such higher temperatures and pressures can adversely affect the thermal stability of the dyes in the new HFC-containing systems.

In practice, the dyes have tended to separate out, or to precipitate out of solution. For example, it was found that although it is possible to mix powdered naphthalimide dyes with a wide range of solvents, it was difficult to maintain the dye in solution when the solvent and dye mixture was further mixed with a refrigerant gas while in its liquid phase, often resulting in the formation of a precipitate when mixed with the liquid gas, having a similar appearance to snow, causing clogging of the valves of the storage cylinder and making the product unfit for sale or use.

### OBJECTS OF THE INVENTION

It is an object of the present invention to provide an improved refrigerant leak detection system which goes at least some way towards overcoming or at least minimising the prior art problems or limitations outlined above.

It is also an object of the present invention to provide an improved leak detection composition that incorporates a fluorescent dye or other visible dye suitable for permanent or long-term inclusion in a hermetic refrigeration system.

It is another object of the present invention to provide an improved refrigerant composition which incorporates a fluorescent dye or other visible indicator composition as an essential permanent component thereof.

It is a further object of the present invention to provide a method of manufacturing such compositions.

It is yet another object of the present invention to provide a method of detecting leaks in a refrigeration system utilising the above referenced compositions.

These and other objects of the invention will become more apparent from the following description.

### DISCLOSURE OF THE INVENTION

The present invention is based on the discovery that small but effective quantities of known fluorescent dyes or other diagnostic compositions may remain permanently in suspension or solution in the liquid refrigerant when stored in pressurised storage vessels (e.g. cylinders) long term. The pre-mixture of the dye or other diagnostic composition in solution, with or without the refrigerant and the refrigeration lubricant allows for simplified introduction of the dye or other diagnostic composition into the hermetic refrigeration system.

According to one aspect of the invention, there is provided a leak detection composition for a refrigeration system comprising a fluorescent dye or other visible diagnostic composition dissolved in or in suspension or emulsion in a solvent for said dye or diagnostic composition together with a refrigeration system lubricant.

According to another aspect of the invention, there is provided a refrigerant composition comprising essentially an admixture of a liquid refrigerant with a fluorescent dye or other visible diagnostic composition dissolved in or in suspension or emulsion in a solvent for the dye or diagnostic composition, and a refrigeration system lubricant. This mixture, when pressurised, provides a refrigerant gas composition including a permanent dye component or other visible indicator.

According to a further aspect of the invention, there is provided a method of detecting leaks in a refrigeration system that uses in combination a refrigerant, a refrigerant system lubricant and a fluorescent dye or other visible diagnostic composition permanently entrained therein, the method comprising the steps of:

preparing a solution of the fluorescent dye or other visible diagnostic composition in a solvent suitable therefor

adding a predetermined amount of the solution from the preceding step to a combination of liquid refrigerant and refrigeration system lubricant to form a stable refrigerant composition having the dye or other visible diagnostic composition dissolved or solubilized therein

charging the hermetic refrigeration system with a predetermined amount of the refrigerant composition from the preceding step

operating the charged system as and when required and determining the presence of a leak site by the presence of a coloured fluorescence or other visible coloration detectable by visual observation or with the aid of a lamp that produces light having an emission wavelength from 300 to 480 nanometers, directed at said refrigeration system.

### DETAILED DESCRIPTION OF THE PREFERRED EMBODIMENTS AND BEST MODE OF CARRYING OUT THE INVENTION

The present invention is directed to the detection of leaks in refrigeration systems employing the new alternative HFC environmentally friendly refrigerants where said refrigeration system is suitable for cooling, freezing, heating, ventilating and air conditioning and where said refrigeration system employs alone or in combination, any material, suitable to function as a heat transfer agent or refrigerant in a hermetic system such as, but not limited to, chlorofluorocarbons (CFC), hydrochlorofluorocarbons (HCFC), hydrofluorocarbons (HFC) and any hydrogen, halogenated or ether derivatives of methane, hydrogen, halogenated, ether or cyclic derivatives either ethane, propane, butane, pentane, mixtures of HCFC, HFC, hydrocarbons, carbon dioxide and ammonia. Examples of the refrigerants include but are not limited to CFC-11, CFC-12, HCFC-22, HCFC-123, HCFC-124, HCFC-142b, HFC-32, HFC-134, HFC-134a, HFC-152, HFC-152a, HFC-143a, HFC-125, HFC-245ca, HFC-245fa and HFC-225ca.

The refrigeration systems can use alone or in combination, refrigeration system lubricants including, but not limited to, hydrocarbons such as natural or refined mineral oils, synthetic hydrocarbons (SHC), alkylbenzenes (AB), polyalphaolefins (PAO) and synthetic polyalkylene glycols that are terminated as mono- or diethers or as esters, and the general class of polyolester lubricants that are either di-, tri-, tetra- or polyfunctional pentaerythritol esters.

The mixture of refrigerants and refrigeration system lubricants can be composed of the aforementioned materials having at least 0.001 grams of general naphthalimide dye (including structures that incorporate any nitrogen alkyl derivatives and any functionalized ring chemistry, both carbocyclic and heterocyclic, with either nitrogen, sulfur, carbon or oxygen) dissolved per 100 grams of refrigeration working fluid.

The choice of dye for inclusion in the refrigerant gas composition is from any suitable known dye which can be dissolved in a solvent and is compatible with the combination of refrigerant and refrigeration system lubricant, and is not precipitated from solution. The preferred dyes are naphthalimide and perylene fluorescent dyes, but are not limited thereto. The dye is incorporated into the solvent generally in the range of about 1 to 5% by weight of the solution, and then entrained into the refrigerant composition in the range of about 0.001 to about 0.1% by weight based on the weight of the dye substance per 100 grams of refrigerant working solution.

The refrigerant composition including the dye entrained therein is circulated throughout the entire hermetic refrigeration system, and in time the system will be inspected for leaks with a light excitation source having emission wavelengths in the range from 300 to 480 nanometers.

The preferred compositions disclosed herein are invisible or of a lesser intensity in ordinary light. When a lamp having a light emission output in the range from 300 to 480 nanometers is directed at the lubricant and naphthalimide dye mixture, a striking fluorescence, for example with the colour yellow to yellow green, is immediately noticeable at the leak site.

Conventionally, refrigerant is supplied by refrigerant wholesalers to service persons and refrigeration equipment manufacturers in pressure vessels able to withstand the vapour pressure of the refrigerant at normal ambient temperatures. Those pressure vessels are commonly referred to simply as “gas cylinders”, notwithstanding that a normally full said gas cylinder is very nearly full of liquid refrigerant in equilibrium with only a relatively small ullage volume of refrigerant vapour. Each said gas cylinder is fitted with a manually operable outlet valve including a standardised hose connector, whereby the cylinder may be connected to standardised manually operable inlet valves, also furnished with standardised hose connectors, for the admission of refrigerant into both the liquid filled high pressure and vapour filled low pressure parts of a refrigeration or air-conditioning system.

The present invention contemplates that a wholesaler or manufacturer may incorporate an effective amount of dye stuff into the refrigerant while filling the said gas cylinders for delivery to the system manufacturer or service provider, to enable the latter persons to charge the system with refrigerant in a normal manner, to thereafter render it unnecessary for a service provider to add the dye composition separately when placing gas in a system or adopt special procedures to detect leaks.

In experiments leading to the present invention it was found that if a conventional diagnostic composition is injected into an already filled cylinder the dye is likely to form a precipitate which will not thereafter re-mix with the liquid refrigerant; but that this could be overcome by injecting a dye containing composition into the liquid refrigerant at a slow and controlled rate as it is piped into the gas cylinder or back to bulk storage by the wholesaler or other filler thereof. It is thought that this is effective because it limits the localised concentration of dye composition in the liquid refrigerant at any one time.

Thus, the invention further consists in a method of filling a gas cylinder with an admixture of liquid refrigerant and an effective amount of a diagnostic dye, comprising the step of continuously injecting a minor flow of a dye into a filler pipe through which a major flow of liquid refrigerant is being fed into a cylinder being filled. They dye may be metered into the filler pipe by any form of positive displacement pump or similiar system running at an appropriate speed to deliver the dye against the pumping and vapour pressure of the refrigerant at the temperature in the pipe.

The above described method of the invention is applicable to the filling of present day gas cylinders. In a less preferred alternative using a special gas cylinder with an auxiliary filling valve the dye may be injected directly into the liquid pool in the cylinder simultaneously with the input of refrigerant through the conventional valve.

As a general rule, the pigments in dyes that are currently used as diagnostic agents are essentially solids made available as powders. Before they can be readily pumped they require to be dissolved in an appropriate liquid solvent. Indeed they are currently marketed as solutions containing about 2% by weight of pigment in a liquid solvent. Therefore the term “dye” as used herein includes within its ambit liquid solutions of the pigment material.

Furthermore, in preferred embodiments the dye is preferably delivered in a dye composition comprising such liquid solutions of pigment, preferably a pigment that fluoresces under the influence of ultra-violet radiation, in admixture with one or more of the following—mineral oils—vegetable oils—surfactants—synthetic oils—esters—or other suitable solvents therefor.

Thus a preferred composition for inclusion in the liquid refrigerant may comprise dye solution containing about 2% by weight of pigment dissolved in an admixture of a combination of the chemicals described above. Those chemicals have been found to reduce or stop the forming of the precipitate previously mentioned.

In a preferred form of the invention a napthalimide dye was solubilized into a refrigerant composition by first dissolving the dye in a solvent mixture comprising:

50% Fatty Acid Ethoxylate

30% Alcohol Ethoxylate

18% Polyolester Oil

2% Naphthalimide Dye

An example of the Fatty Acid Ethoxylate is an Ethylene Oxide Ester based on Oleic Acid. It has six mols of Ethylene Oxide per mol of Oleic Acid.

An example of the Alcohol Ethoxylate is Cetyl Oleyl Alcohol Ethoxylate, which has two mols of Ethylene Oxide per mol of Cetyl Oleyl Ethoxylate.

Polyolester Oil is a lubricant used in air conditioning systems. Particularly those using HFC refrigerants. This chemical could be replaced by any of the lubricants used in refrigeration and air conditioning systems.

Napthalimide dyes are recognised for their suitability for fluorescing when exposed to light between 300-480 nm.

R134a is the gas most commonly used in conjunction with this dye mixture. R134a, is an HFC (hydrofluorcarbon) however suitability is not limited to that gas. It is also suitable for use with but not limited to, HCFC's (hydrochlorofluorocarbons) and hydrogen, halogenated, ether or cyclic derivatives of ethane, propane, butane, pentane, mixtures of HCFC, HFC, hydrocarbons, carbon dioxide and ammonia. The dyes able to be used are not limited to Naphalimide dye. It is also suitable for use with Perylene dye and other dyes used for their ability to fluoresce when exposed to light between 300-480 nm. The above exemplified dye in solvent solution is then mixed with the liquid refrigerant in a ratio of one part per one hundred.

It was found that although it was not difficult to mix powdered Napthalimide dye with a wide range of solvents, there was considerable difficulty making the powder stay in solution when the solvent and powder mixture were mixed with a refrigerant gas while in its liquid phase. Unless a suitable solvent or mixture of solvents was used this mixture would form a precipitate when mixed with the liquid gas. This precipitate had a similar appearance to snow and rendered the product unfit for sale or use.

The above described mixture produces acceptable results but other mixtures and chemicals can be used to achieve a similar outcome. These include but are not limited to mineral based oils and synthetic Hydrocarbon (SHC) oil, Polyalkylene glycols and other chemicals used for lubrication of air conditioning and refrigeration systems, fatty acids such as Oleic Acid and other “vegetable oils”, esters and surfactants including but not limited to fatty acid Ethoxylates and other Ethoxylates.

In respect of the present invention, the inventor has speculated that the chemical composition of the dye's solvents must be such that those chemicals used are not completely soluble in the refrigerant gas. If solvents such as (but not limited to) oils, intended for use with a certain refrigerant are used to carry the dye in solution it was found that when the dye and solvent are mixed with the liquid refrigerant, the solvent and refrigerant become bonded and the dye is released from the solvent and then will appear as a solid precipitate in the refrigerant gas.

Only those chemicals, which are not fully soluble with the chosen refrigerant, can be used to carry the dye without forming a precipitate. However the solvent must be soluble to a limited extent or a situation in such as with oil and water will occur.

Although an exemplary embodiment of the present invention has been described, it will be apparent to those having ordinary skill in the art that a number of changes, modifications or alterations to the invention described herein may be made, none of which depart from the spirit of the present invention. All such changes, modifications and alterations should therefore be seen as being within the scope of the present invention.

It should be appreciated that the present invention provides a substantial advance in the detection of refrigeration system leaks, providing all of the herein-described advantages without incurring any relative disadvantages.

1. (canceled).

2. A containerized refrigerant product as claimed in claim 13, further comprising a refrigeration system lubricant.

3. A containerized refrigerant product as claimed in claim 13, wherein the refrigerant is selected from HFC, HCFC, hydrocarbons, and derivatives and mixtures thereof.

4. (canceled).

5. A containerized refrigerant product as claimed in claim 2, wherein the refrigeration system lubricant is selected from hydrocarbons including natural or refined mineral oils, synthetic hydrocarbons, alkylbenzenes, polyalphaolefins, synthetic polyalklene glycols and polyolester lubricants.

6. (canceled).

7. A containerized refrigerant product as claimed in claim 15, wherein the dye comprises from about 0.001 to about 5.0% by weight of the composition based on the weight of the dye per 100 grams of refrigerant.

8. A liquefied refrigerant composition comprising in combination a non-CFC refrigerant and a UV fluorescent dye pre-dissolved in a solvent for said dye, wherein said solvent is other than the refrigerant or a refrigeration system lubricant, whereby said refrigerant, dye and solvent comprise a uniformly homogenous composition in the liquid phase, further comprising a refrigeration system lubricant, and wherein the solvent comprises a mixture of fatty acid ethoxylate and alcohol ethoxylate.

9. A refrigerant composition as claimed in claim 8, wherein the fatty acid ethoxylate is an ethylene oxide ester based on oleic acid.

10. A refrigerant composition as claimed in claim 8, wherein the alcohol ethoxylate is cetyl oleyl alcohol ethoxylate.

11. A containerized refrigerant product as claimed in claim 13, suitable for operation in a system in a preselected mode including cooling, freezing, heating, ventilating and air conditioning.

12. A containerized refrigerant product as claimed in claim 11, wherein the air conditioning system is a motor vehicle air conditioning system.

13. A containerized refrigerant product comprising,
a pressurized cylinder, and
a liquefied refrigerant composition disposed in said cylinder, said composition comprising in combination a non-CFC refrigerant and a UV fluorescent dye pre-dissolved in a solvent for said dye, wherein said solvent is other than the refrigerant or a refrigeration system lubricant, whereby said refrigerant, dye and solvent comprise a uniformly homogenous composition in the liquid phase within said cylinder.

14. The containerized refrigerant product as set forth in claim 13, wherein:
said refrigerant is selected from the group comprising HCFC-22, HCFC-123, HCFC-124, HCFC-142b, HFC-32, HFC-134, HFC-134a, HFC-152, HFC-152a, HFC-143a, HFC-125, HFC-245ca, HFC 225ca, butane and propane;
said solvent comprises a mixture of fatty acid ethoxylate and alcohol ethoxylate, and
said composition further comprises a lubricant selected from hydrocarbons including natural or refined mineral oils, synthetic hydrocarbons, alkylbenzenes, polyalphaolefins, synthetic polyalklene glycols and polyolester lubricants.

15. The containerized refrigerant product as set forth in claim 13, wherein:
the dye is a naphthalimide fluorescent dye.
